(19) United States
(12) Patent Application Publication
(10) Pub. No.: US 2026/0337955 A1
(43) Pub. Date: Oct. 29, 2026

(54) CLEAT CONNECTOR

(71) Applicant: Bruce Delahunty, Queensland (AU)

(72) Inventor: Bruce Delahunty, Queensland (AU)

(21) Appl. No.: 19/103,785

(22) PCT Filed: Aug. 22, 2023
(86) PCT No.: PCT/AU2023/050794

§ 371 Date: Feb. 13, 2025

(30) Foreign Application Priority Data
Aug. 22, 2022 (AU) 2022902395

(51) Int. Cl. E04B 1/38; E04B 1/58

(52) U.S. Cl. CPC E04B 1/388; E04B 1/5831; E04B 2001/389

(57) ABSTRACT

A cleat connector for attachment to a square hollow section box includes a body having a channel adapted to slidably receive and secure to the square hollow section box, the body comprising a base and a pair of walls extending from opposing ends thereof that define the channel, the pair of walls including a first wall and a second wall. The cleat connector is integrally formed and includes at least one extension adapted to secure a structure thereto.

### CROSS REFERENCE TO RELATED APPLICATIONS

The present application claims the priority benefits of International Patent Application No. PCT/AU2023/050794, filed on Aug. 22, 2023, and claims benefit of AU 2022902395, filed on Aug. 22, 2022, which are hereby incorporated herein by reference in their entireties.

### FIELD OF THE INVENTION

The present invention relates to the field of construction. Particularly, the present invention relates to the field of reinforcement of, or connections for, buildings. More particularly, the present invention relates to a cleat connector for use in construction.

### BACKGROUND TO THE INVENTION

Any reference to background art herein is not to be construed as an admission that such art constitutes common general knowledge in Australia or elsewhere.

Housing and structures form an integral part of society. In this regard, housing provides shelter and accommodation to a person. A structure must be sufficiently strong to ensure that it maintains structural integrity. One prior art method of maintaining the structural integrity of a building is utilizing a cleat to secure adjacent structures or to reinforce said structure.

Typically, a cleat is utilized to provide further structural integrity of a building by providing connections between beams and columns. Typically, the cleat is attached to a pair of adjacent structures to provide structural integrity. In the event that a structure is a metal structure (e.g., square hollow section, SHS), a welder is required to secure a cleat to the metal structure. It will be appreciated that this is time consuming and expensive in relation to at least labour costs.

It would be advantageous to address one or more of the above issues and/or provide the consumer with a useful or commercial alternative.

### SUMMARY OF THE INVENTION

In a first aspect, although it need not be the only or indeed the broadest aspect, the invention resides in a cleat connector for attachment to a column structure comprising:
a body have a channel adapted to secure to the column structure; and
at least one extension adapted to secure a structure thereto.

In an embodiment, the body comprises a base and a pair of walls extending from opposing ends thereof. In some embodiments, the body comprises a number to attachment portions that are adapted to secure to the column structure.

In one embodiment, the cleat connector comprises 1, 2, 3 or 4 extension(s). In an embodiment, the cleat connector comprises 1, 2 or 3 extensions. The extension suitably extends away from one or more of the base, first wall or second wall. In a preferred embodiment, the extension is suitably perpendicular to the surface in which it extends away from.

In certain embodiments, base, the first wall and/or the second wall comprise at least one attachment portion adapted to secure to the column structure. In an embodiment, the attachment portion comprises apertures adapted to receive a fastening member.

In an embodiment, the cleat connector is integrally formed.

In an embodiment, each extension comprises a side wall and one or more securing portions adapted to secure to a structure. In certain embodiments, the securing portion is rotatably connected to the side wall. In embodiments, each extension comprises 1, 2, 3 or 4 securing portions rotatable connected to the side wall. In one embodiment, a rotation mechanism connects the securing portion to a respective side wall. In an embodiment, the securing portion is rotatable in the plane of the side wall.

In embodiments, each extension comprises at least one aperture adapted to secure to the structure.

In certain embodiments, the body further comprises a top connected to the base and the pair of walls.

In one embodiment, each extension of the at least one extension extends perpendicularly away from the top. In embodiments, each extension comprises at least one aperture adapted to secure to the structure.

In one embodiment, the column structure is a square hollow section box.

In an embodiment, the column structure is a timber structure and/or a metal structure.

In an embodiment, the column structure has a substantially consistent cross-section. In embodiments, the column structure has a square cross-section or a rectangular cross-section. In an embodiment, the column structure is a square hollow section or a rectangular hollow section. In an embodiment, the column structure is a parallel flange channel.

In an embodiment, the structure comprises timber and/or metal. In an embodiment, the structure is a parallel flange channel.

In one embodiment, the cleat connector is for use in balconies, verandahs beams, roof beams, floor bearer supports, garages, carports, pergolas and/or stair landings. In an embodiment, the cleat connector when used in balconies, verandahs beams, roof beams, floor bearer supports, garages, carports, pergolas and/or stair landings. In an embodiment, the clear connector secures a base and/or first wall to a side wall.

The various features and embodiments of the present invention referred to in the individual sections above and in the description which follows apply, as appropriate, to other sections, mutatis mutandis. Consequently, features specified in one section may be combined with features specified in other sections as appropriate.

Further features and advantages of the present invention will become apparent from the following detailed description in conjunction with the drawings.

### BRIEF DESCRIPTION OF THE DRAWINGS

To assist in understanding the invention and to enable a person skilled in the art to put the invention into practical effect, embodiments of the invention will be described by way of example only with reference to the accompanying drawings, in which:

FIG. 1 shows an embodiment of a cleat connector;

FIG. 2 shows another embodiment of a cleat connector;

FIG. 3 shows a further embodiment of a cleat connector;

FIG. 3a shows another embodiment of a cleat connector;

FIG. 4 shows one embodiment of a cleat connector;

FIG. 5 shows an embodiment of a cleat connector;

FIG. 6a shows an embodiment of a cleat connector comprising a single extension connected to a single securing portion rotatably connected thereto;

FIG. 6b shows an embodiment of a cleat connector comprising a single extension connected to two securing portions rotatably connected thereto;

FIG. 7a shows an embodiment of a cleat connector comprising two extensions where each extension is connected to a single securing portion rotatably connected thereto;

FIG. 7b shows a similar embodiment to that shown in FIG. 7a with the exception that the extensions are substantially in the same plane;

FIG. 7c shows an embodiment of the securing portion;

FIG. 8a shows an embodiment of a cleat connector that has a single extension;

FIG. 8b shows a similar embodiment to that shown in FIG. 8a with the exception that the extension comprises second apertures;

FIG. 8c shows a similar embodiment to that shown in FIGS. 8a and 8b with the exception that the extension comprises third apertures;

FIG. 9a shows a similar embodiment to FIG. 8a with the exception that the cleat connector comprises two extensions wherein each extension is adapted to secure to a single structure;

FIG. 9b shows a similar embodiment to FIG. 8b with the exception that the cleat connector comprises two extensions wherein each extension is adapted to secure to two structures;

FIG. 9c shows a similar embodiment to FIG. 8c with the exception that the cleat connector comprises two extensions wherein each extension is adapted to secure to three structures;

FIG. 10a shows an embodiment of a cleat connector having a single extension extending away from the top;

FIG. 10b shows an embodiment of a cleat connector of FIG. 10a securing a structure;

FIG. 10c shows an embodiment of a cleat connector having a single extension adapted to secure multiple structures;

FIG. 10d shows an embodiment of a cleat connector of FIG. 10c securing two structures;

FIG. 10e shows an embodiment of a cleat connector having two extensions each adapted to secure a different structure;

FIG. 10f shows an embodiment of a cleat connector of FIG. 10e securing two structures;

FIG. 11a shows an embodiment of a cleat connector having a single extension;

FIG. 11b shows a similar embodiment to FIG. 11a with the exception that it comprises two extensions;

FIG. 11b shows a similar embodiment to FIG. 11b with the exception of the orientation of the extensions;

FIG. 11d shows a similar embodiment to FIG. 11a with the exception that this cleat connector comprises three extensions;

FIG. 12a shows another embodiment of a cleat connector having a single extension;

FIG. 12b shows a similar embodiment to FIG. 11a with the exception that this cleat connector comprises a pair of extensions that are aligned;

FIG. 12c a similar embodiment to FIG. 11b with the exception that the pair of extensions are perpendicular to one another; and

FIG. 12d shows a similar embodiment to FIG. 11a with the exception that this cleat connector comprises three extensions.

### DETAILED DESCRIPTION OF THE INVENTION

Embodiments of the present invention reside primarily in a cleat connector. Accordingly, the device and method steps have been illustrated in concise schematic form in the drawings, showing only those specific details that are necessary for understanding the embodiments of the present invention, but so as not to obscure the disclosure with excessive detail that will be readily apparent to those of ordinary skill in the art having the benefit of the present description.

In this specification, adjectives such as first and second, left and right, and the like may be used solely to distinguish one element or action from another element or action without necessarily requiring or implying any actual such relationship or order.

Words such as “comprises” or “includes” are intended to define a nonexclusive inclusion, such that a process, method, article, or apparatus that comprises a list of elements does not include only those elements but may include other elements not expressly listed, including elements that are inherent to such a process, method, article, or apparatus.

As used herein, the term about’ means the amount is nominally the number following the term about’ but the actual amount may vary from this precise number to an unimportant degree.

As used herein, the term cleat’ refers to a piece of material (such a strip) that provides strength and/or support. The material is suitably fastened across adjacent column structures, side walls and/or bases to provide strength and/or support. This is generally achieved by providing a connection to a timber beam, bracing rod or steel angle.

As used herein, the term ‘column structure’ is suitably a metal column. In an embodiment, the column structure has a consistent cross-section. In embodiments, the column structure has a square cross-section or a rectangular cross-section. In an embodiment, the column structure is a square hollow section or a rectangular hollow section. In an embodiment, the column structure is a parallel flange channel. In an embodiment, the structure is suitably formed of metal or timber. It will be appreciated that the above list of examples are for exemplification purposes only and the present invention can be utilized with other column structures. It will also be appreciated that the column structure can have varying sizes and the present invention is simply adapted for said size. It will be appreciated that the square hollow section (SHS) can be 75.89, 100, 125, 150 & 200 SHS.

The present invention is predicated on the finding that a cleat connector can provide simply and easy securement to a column structure without the need of a welder. The present invention addresses one or more of the issues mentioned hereinabove.

In a first aspect, although it need not be the only or indeed the broadest aspect, the present invention resides in a cleat connector for attachment to a column structure comprising a body having a channel adapted to secure to the column structure, and at least one extension adapted to secure a timber structure thereto.

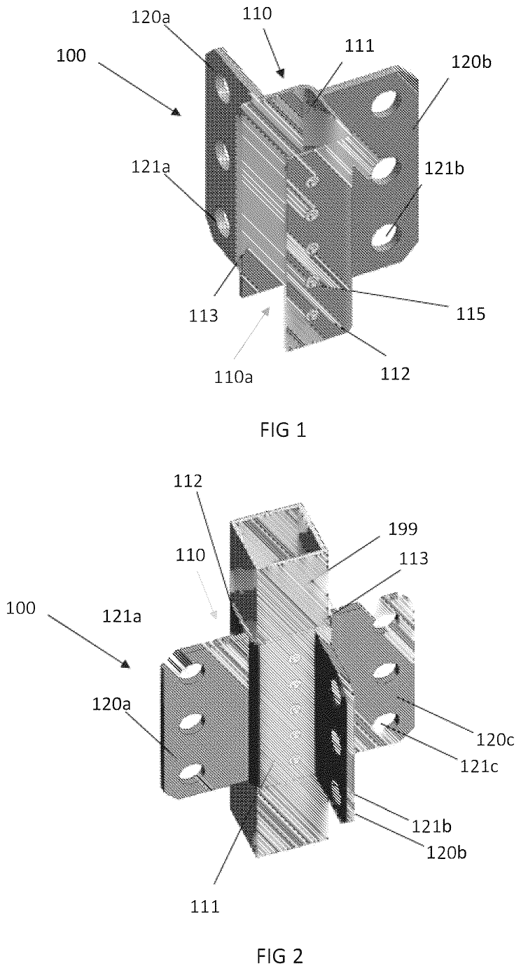

Shown in FIG. 1 is an embodiment of a cleat connector. The cleat connector 100 comprises a body 110 and at least one extension. The body 110 has a channel 110a adapted to secure to a column structure 199. The body 110 comprises a base 111 and a pair of walls extending from opposing ends thereof. In the embodiment shown, the base 111 comprises a first end and a second end. A first wall 112 extends away from the first end. A second wall 113 extends away from the second end. In a preferred embodiment, the first wall 112 and second wall 113 extend away from the base 111 in the same direction. In an embodiment, the first wall 112 and the second wall 113 extend perpendicularly to the base 111. In one embodiment, the first wall 112 and the second wall 113 are substantially parallel. The body 110 comprises a number of attachment portions that are adapted to secure to the column structure 199. In one embodiment, the attachment portions comprise one or more apertures 115 adapted to receive a fastening member. In the embodiment shown, the first wall 112 comprises the attachment portions. However, it will be appreciated that the attachment portions may be located on one or more of the first wall, second wall and base. The body 110 can be suitably attached or affixed to the column structure 199 with a fastening member. In one embodiment, the column structure is steel square box. It will be appreciated that the base, first wall and second wall may be sized and dimensioned to receive, or snugly receive, a column structure. That is, the channel is sized and dimensioned to the desired column structure. A non-limiting example of the fastening member include screws. Non-limiting examples of the fastening members include Tek screws or bolts. However, it will be appreciated that the above list merely exemplifies some of the fastening members that can be utilized with the present invention. It will be appreciated that the body may further comprise a wall connecting a distal end of the first wall to the distal end of the second wall.

The extension(s) 120 are adapted to secure a structure. In one embodiment, the structure is a timber structure or a metal structure. The present description has been described herein in relation to a timber structure for ease of description; however, the person skilled in the art will appreciate that the cleat connector may be utilized with other materials (such as metal, e.g., stainless steel, mild steel, and/or galvanized steel). The extension(s) extend away from body 110. In one embodiment, the cleat connector 100 comprises 1, 2, 3 or 4 extension(s). In one embodiment, the cleat connector 100 comprises 1, 2 or 3 extension(s). The extension suitably extends away from one or the base 110, first wall 112 or second wall 113. In a preferred embodiment, the extension is suitably perpendicular to the surface in which it extends away from. In the embodiment shown in FIG. 1, the cleat connector 100 comprises two extensions 120a, 120b. Each extension 120a, 120b comprises a number of securing portions. In one embodiment, the securing portion comprises one or more respective apertures 121a, 121b. In the embodiment shown in FIG. 1, extension 120a extends away from first wall 112 and extension 120b extends away from base 111. In this embodiment, the extension 120a can be secured to a timber structure and extension 120b can be secured to another timber structure. In this embodiment, the timber structures are perpendicular to one another. It will be appreciated that, depending on the situation the extension may be located at different angles relative to one another. Alternatively, only a single extension may be present when a single timber structure is required. In an embodiment, the timber structure is a timber beam.

Shown in FIG. 2 is an embodiment of a cleat connector. For the ease of description, the cleat connector shown in FIG. 2 has been numbered with a similar numbering system as FIG. 1. The main difference between the cleat connector of FIG. 1 and FIG. 2 is the number of extensions. In the embodiment shown in FIG. 2, the cleat connector 100 comprises three extensions 120a, 120b, 120c. The extensions 120a, 120b, 120c extend away from first wall 112, base 111 and second wall 113, respectively. Each extension 120a, 120b, 120c comprises a number of securing portions. The extensions 120a, 120b, 120c comprise one or more respective apertures 121a, 121b, 121c. Furthermore, in the embodiment shown, the attachment portions are formed in the base 111. In the embodiment shown, apertures 115 are formed in the base. As shown, fastening members are utilized to secure the body to the column structure 199. Non-limiting examples of the fastening members include Tek screws or bolts. However, it will be appreciated that the above list merely exemplifies some of the fastening members that can be utilized with the present invention. In this embodiment, the cleat connector is adapted to secure to three different timber structures and are perpendicular to one another.

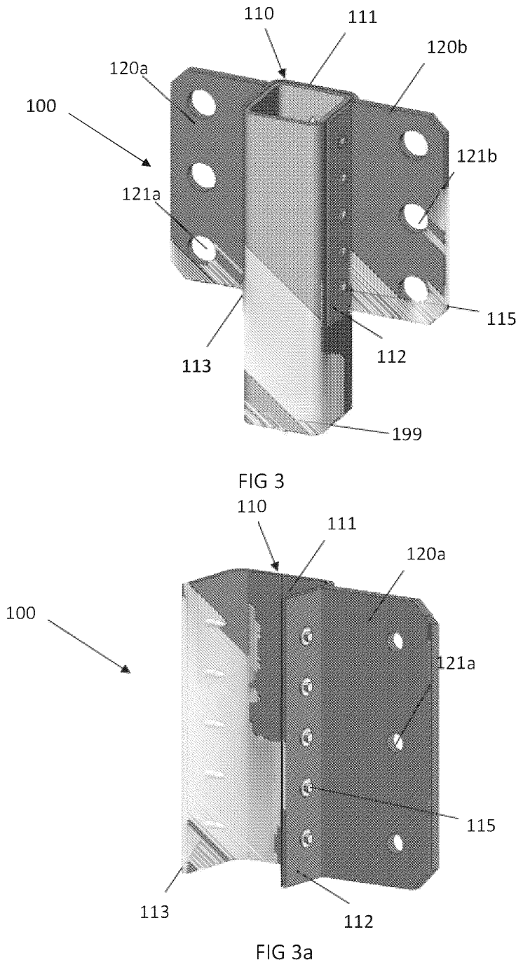

Shown in FIG. 3 is an embodiment of a cleat connector. For the ease of description, the cleat connector shown in FIG. 3 has been numbered with a similar numbering system as FIGS. 1 and 2. The main difference between the cleat connector of FIG. 3 and FIG. 1 is the location of the extensions. In this regard, the extension 120a extends away from the second wall 113 and the extension 120b extends away from the first wall 112. In this embodiment, the extensions are substantially parallel or in the same plane. In the embodiment shown, the attachment portions are formed in the first wall 112. In the embodiment shown, apertures 115 are formed in first wall 112. As shown, fastening members are utilized to secure the body to the column structure 199. Non-limiting examples of the fastening members include Tek screws or bolts. However, it will be appreciated that the above list merely exemplifies some of the fastening members that can be utilized with the present invention. In this embodiment, the cleat connector is adapted to secure to two different timber structures and are substantially in the same plane.

Shown in FIG. 3a is an embodiment of a cleat connector. For the ease of description, the cleat connector shown in FIG. 3a has been numbered with a similar numbering system as FIGS. 1 to 3. The main difference between the cleat connector of FIG. 3 and FIG. 1 is the number of extensions. In this regard, this clear connector comprises a single extension. As shown, the extension 120a extends away from first wall 112. In the embodiment shown, the attachment portions are formed in both the first wall 112 and the second wall 113. Shown in FIG. 3a are fastening members utilized with the apertures 115 of the attachment portions.

In one embodiment, the cleat connector is integrally formed. As used herein, the term ‘integrally formed’ means being formed of a single material. Alternatively, the cleat connector may be formed of a number of components.

Each extension is suitably adapted to secure to one or more timber structure(s) (mentioned in more detail hereinafter). In an embodiment, each extension comprises a side wall coupled to one or more securing portions adapted to secure to a timber structure. In this regard, the securing portion is rotatably adjustable relative to the side wall.

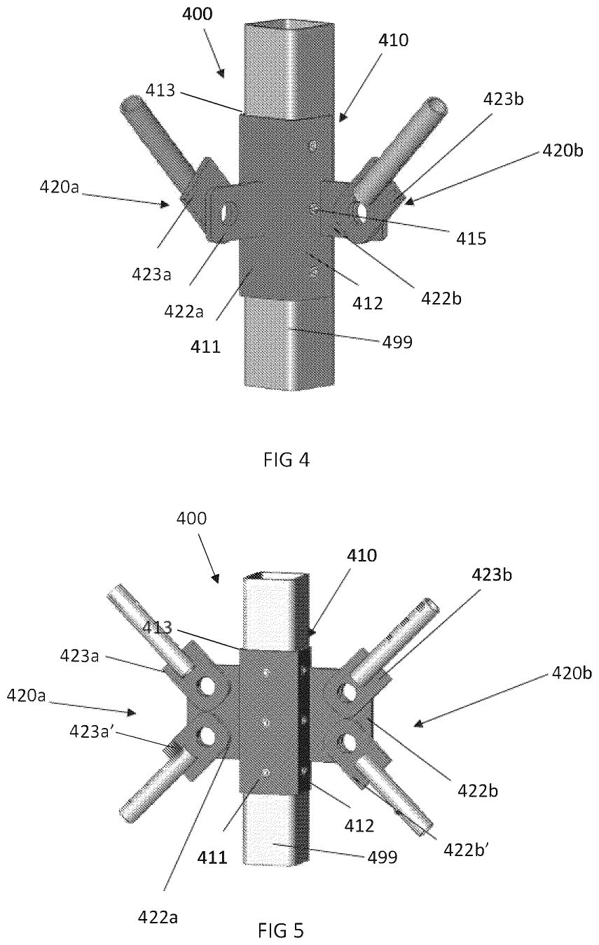

Shown in FIG. 4 is an embodiment of a cleat connector 400. The description hereinabove for cleat connector 100 is substantially equally applicable for cleat connector 400.

The cleat connector 400 comprises a body 410 and at least one extension. The body 410 has a channel (not shown) adapted to secure to a column structure 499. The body 410 comprises a base 411 and a pair of walls extending from opposing ends thereof. In the embodiment shown, the base comprises a first end and a second end. A first wall 412 extends away from the first end. A second wall 413 extends away from the second end. In a preferred embodiment, the first wall 412 and second wall 413 extend away from the base 411 in the same direction. In an embodiment, the first wall 412 and the second wall 413 extend perpendicularly to the base 411. In one embodiment, the first wall 412 and the second wall 413 are substantially parallel. The body 410 comprises a number of attachment portions that are adapted to secure to the column structure 499.

In one embodiment, the attachment portions comprise one or more apertures 415 adapted to receive a fastening member. In the embodiment shown, the first wall 412 comprises the attachment portions. The body 410 can suitably be attached or affixed to the column structure 499 with a fastening member. In one embodiment, the column structure is steel square box. It will be appreciated that the base, first wall and second wall may be sized and dimensioned to receive, or snugly receive, a column structure. That is, the channel is sized and dimensioned to the desired column structure. Non-limiting examples of the fastening members include Tek screws or bolts. However, it will be appreciated that the above list merely exemplifies some of the fastening members that can be utilized with the present invention.

As shown, extension 420a comprises a side wall 422a connected to base 411, and a securing portion 423a is suitably adapted to be rotatably adjustable and/or connected relative to the side wall 422a. In this regard, the securing portion may be part of the crossbrace. Similarly, extension 420b comprises a side wall 422b connected to first side wall 412, and a securing portion 423b is suitably adapted to be rotatably adjustable and/or connected relative to the side wall 422b. The securing portion 423b may be part of the cross brace. In this embodiment, the securing portion can be adjusted by rotation and this allows for the member being secured to have different orientations/angles. It will be appreciated that this allows for a significant amount of adjustment and saves time. As shown, the securing portion is rotatable in the plane of the side wall.

Shown in FIG. 5 is an embodiment of a cleat connector. For the ease of description, the cleat connector shown in FIG. 5 has the same numbering as that provided for FIG. 4 above. The main difference between the cleat connector of FIG. 5 and FIG. 4 is the number of securing portions per extension. In the embodiment shown, each side wall 422a, 422b is adapted to be rotatably adjustable relative to a respective securing portion. In this regard, a second securing portion 423a′ or 423b′ are adapted to be rotatably adjustable relative to the side wall 422a and 422b, respectively. As mentioned above, the securing portion are suitably part of the crossbrace. In the embodiment shown, each extension is adapted to be secured to two securing portions. Initially, the crossbrace and securing portion are rotatably adjustable relative and this allows for the angle of the cleat attached thereto to be adjusted easily. It will be appreciated that each extension may comprise any number of securing portions. Once the appropriate angle of the crossbrace is found, the securing portion is suitably fixed or secured to the side wall.

Similar to the above, the cleat connector may comprise 1, 2, 3 or 4 extensions. In one embodiment, the cleat connector 100 comprises 1, 2 or 3 extension(s). In one embodiment, each extension may comprise 1, 2, 3 or 4 securing portions attached thereto.

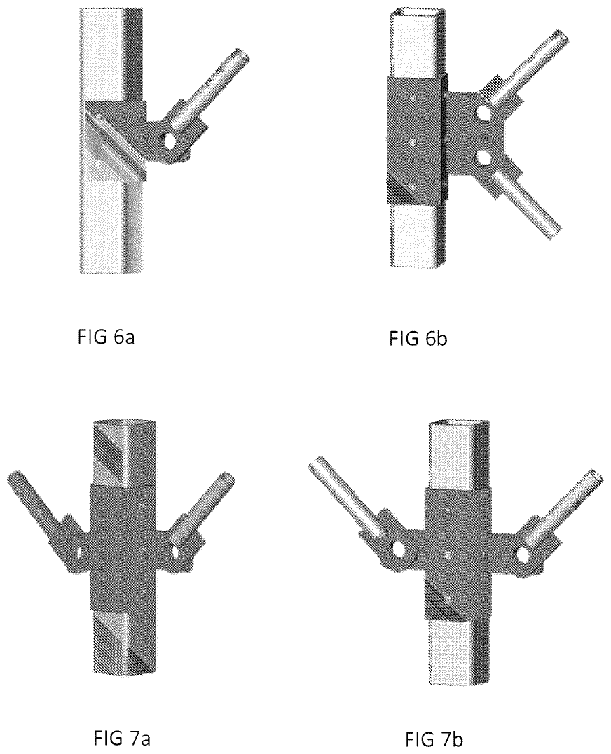

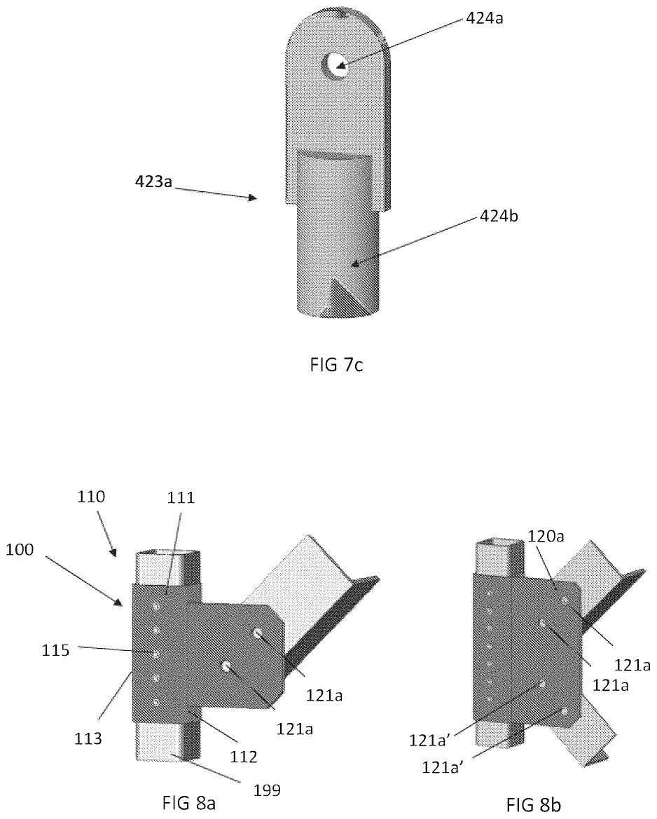

Shown in FIG. 6a is an embodiment of a cleat connector that comprises a single extension being coupled to a single securing portion rotatably connected thereto. Shown in FIG. 6b is an embodiment of a cleat connector that comprises a single extension being coupled to two securing portions rotatably connected thereto. Shown in FIG. 7a is an embodiment of a cleat connector comprising two extensions where each extension is coupled to a single securing portion. The embodiment shown in FIG. 7a has the extension and thus securing portions substantially perpendicular to one another. Shown in FIG. 7b is a similar embodiment to that shown in FIG. 7a with the exception that the extension are substantially in the same plane.

Shown in FIG. 7c is an embodiment of a securing portion 423a. The securing portion 423a comprises a connection portion 424a. The connection portion 424a comprises an aperture. The securing portion 423a comprises a second connection portion 424b. The second connection portion 424b comprises a threaded blind hole therein (not shown). The threaded blind hole is adapted to receive a threaded bar. In one embodiment, the threaded blind hole is sized and dimensioned to receive the desired threaded bar. Non-limiting examples of the threaded bar include m12, m16, m20, m24, m30, m36 . . . . The connection portion is adapted to connect to a side wall. In one embodiment, the aperture is adapted to receive a protrusion of the side wall. Alternatively, the side wall may comprise an aperture. In this embodiment, the aperture or a side wall and the aperture of the connection portion are adapted to receive a member therethrough to facilitate relative rotation thereof. It will be appreciated that the description of this securing portion may suitably be applicable to the other securing portions mentioned herein.

It will be appreciated from the above that the extension may be rotatable adjustable relative to a securing portion or have the securing portion formed therewith. In this regard, it will be appreciated that an extension may comprise one or more securing portions for securing one or more structures.

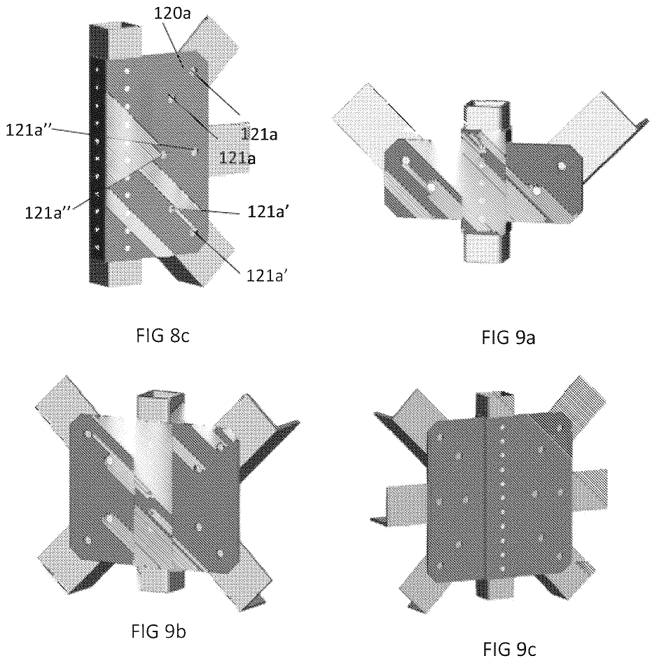

For the ease of description, the cleat connector shown in FIGS. 8a-8c has been numbered with a similar numbering system as FIG. 1. Shown in FIG. 8a is an embodiment of a cleat connector 100 that has a single extension. The body 110 has a channel (not shown) adapted to secure to a column structure 199. The body 110 comprises a base 111 and a pair of walls extending from opposing ends thereof. In the embodiment shown, the base comprises a first end and a second end. A first wall 112 extends away from the first end. A second wall 113 extends away from the second end. In a preferred embodiment, the first wall 112 and second wall 113 extend away from the base 111 in the same direction. In an embodiment, the first wall 112 and the second wall 113 extend perpendicularly to the base 111. In one embodiment, the first wall 112 and the second wall 113 are substantially parallel. The body 110 comprises a number to attachment portions that are adapted to secure to the column structure 199. In one embodiment, the attachment portions comprise one or more apertures 115 adapted to receive a fastening member. In the embodiment shown, the base 111 comprises the attachment portions. The body 110 can suitably attached or affixed to the column structure 199 with a fastening member. In one embodiment, the column structure is steel square box. It will be appreciated that the base, first wall and second wall may be sized and dimensioned to receive, or snugly receive, a column structure. That is, the channel is sized and dimensioned to the desired column structure. A non-limiting example of the fastening member include screws (e.g., metal Tek screws). Non-limiting examples of the fastening members include Tek screws or bolts. However, it will be appreciated that the above list merely exemplifies some of the fastening members that can be utilized with the present invention.

The extension(s) 120 are adapted to secure a structure. In one embodiment, the structure is a timber structure or metal structure. The extension(s) extend away from body 110. In one embodiment, the cleat connector 100 comprises 1, 2, 3 or 4 extension(s). In one embodiment, the cleat connector 100 comprises 1, 2 or 3 extension(s). The extension suitably extends away from one or the base 110, first wall 112 or second wall 113. In a preferred embodiment, the extension is suitably perpendicular to the surface in which is extends away from. In the embodiment shown in FIG. 8a, the cleat connector 100 comprises a single extension 120a. The extension 120a comprises a number of securing portions. In an embodiment, the attachment portion 120a comprises apertures 121a which together secure to the structure. In the embodiment shown in FIG. 8, extension 120a extends away from first wall 112.

Shown in FIG. 8b is a similar embodiment to that shown in FIG. 8a. The main difference is that the extension 120a comprises second apertures 121a′ which may together secure to another structure. Shown in FIG. 8c is a similar embodiment to that shown in FIGS. 8a and 8b. The main difference is that the extension comprises third apertures 121a″ which may together secure to another structure. It will be appreciated that in this embodiment, multiple structures may be secured to the column I structure.

For the ease of description, the cleat connector shown in FIGS. 9a-9c has been numbered with a similar numbering system as FIGS. 1, 3 and 9. Shown in FIG. 9a is a similar embodiment to FIG. 8a with the main difference being that the cleat connector comprises two extensions wherein each extension is adapted to secure to a single structure. Shown in FIG. 9b is a similar embodiment to FIG. 8b with the main difference being that the cleat connector comprises two extensions wherein each extension is adapted to secure to two structures. Shown in FIG. 9c is a similar embodiment to FIG. 8c with the main difference being that the cleat connector comprises two extensions wherein each extension is adapted to secure to three structures.

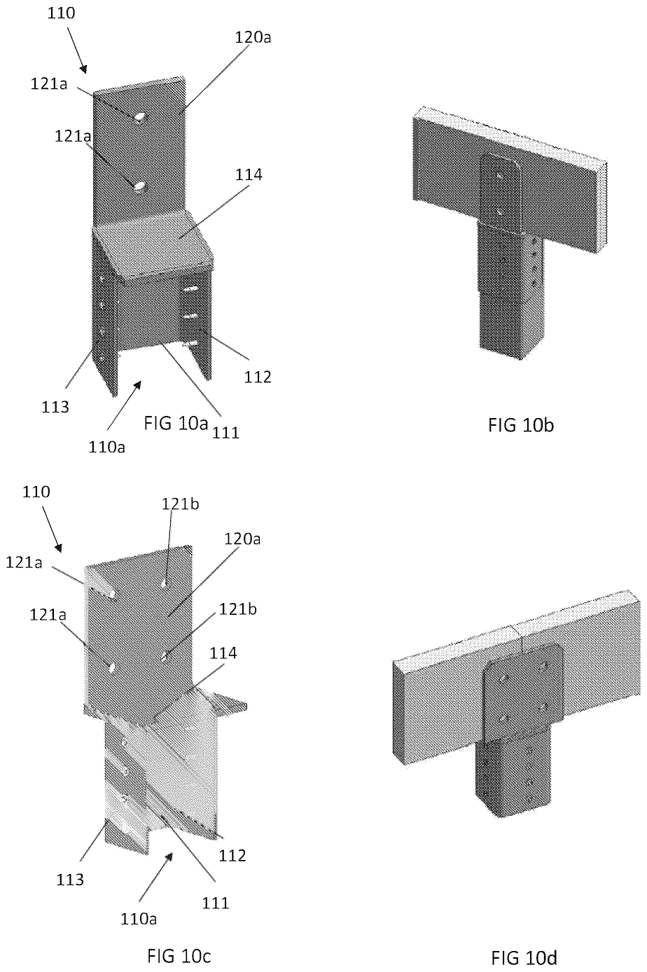

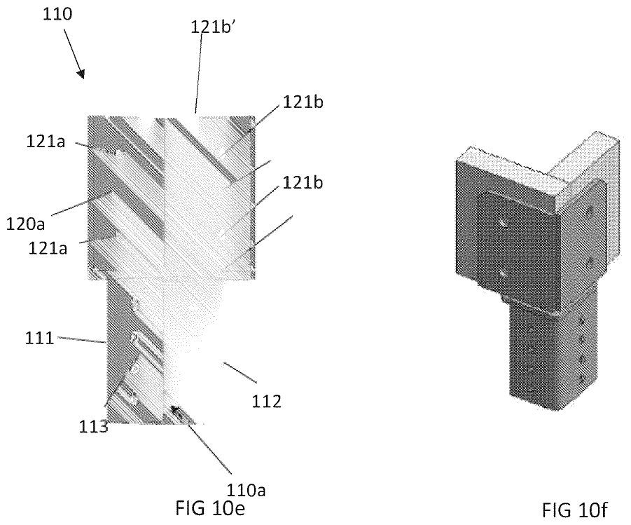

It will be appreciated by the person skilled in the art that the present cleat connector may also be utilized above a column structure. Shown in FIGS. 10a-f are embodiments wherein a cleat connector is adapted to connect to an upper end of a column structure.

For ease of description, the cleat connector shown in FIGS. 10a-10f has been numbered with a similar numbering system as FIG. 1. Shown in FIG. 10a is an embodiment of a cleat connector 100 that has a single extension. The body 110 has a channel 110a adapted to secure to a column structure. The body 110 comprises a base 111 and a pair of walls extending from opposing ends thereof. In the embodiment shown, the base comprises a first end and a second end. A first wall 112 extends away from the first end. A second wall 113 extends away from the second end. In a preferred embodiment, the first wall 112 and second wall 113 extend away from the base 111 in the same direction. In an embodiment, the first wall 112 and the second wall 113 extend perpendicularly to the base 111. In one embodiment, the first wall 112 and the second wall 113 are substantially parallel. The body 110 comprises a number to attachment portions that are adapted to secure to the column structure. In one embodiment, the attachment portions comprise one or more apertures shown with fastening members therein. In the embodiment shown, the first wall 112 and second wall 113 comprises the attachment portions. The body 110 can suitably attached or affixed to an upper end of the column structure with a fastening member. In the embodiment shown, the base 111, first wall 112 and second wall 113 are connected by a top 114. The top 114 suitably engages a top of the column structure to rest thereon. In one embodiment, the column structure is steel square box. It will be appreciated that the base, first wall and second wall may be sized and dimensioned to receive, or snugly receive, a column structure. That is, the channel is sized and dimensioned to the desired column structure. A nonlimiting example of the fastening member include screws (e.g., metal Tek screws). Non-limiting examples of the fastening members include Tek screws or bolts. However, it will be appreciated that the above list merely exemplifies some of the fastening members that can be utilized with the present invention.

In the embodiment shown, the cleat connector 100 comprises an extension 120a adapted to secure a structure. In one embodiment, the structure is a timber structure or a metal structure. The present description has been described herein in relation to a timber structure for ease of description; however, the person skilled in the art will appreciate that the cleat connector may be utilized with other materials (such as metal, e, g., stainless steel, mild steel, and/or galvanized steel). In one embodiment, the cleat connector 100 comprises 1, 2, 3 or 4 extension(s). In one embodiment, the cleat connector 100 comprises 1, 2 or 3 extension(s). In the embodiment shown, the extension 120a extends away from the top 114. A structure can suitably abut the top 114 and be secured to the extension 120a. In a preferred embodiment, the extension is suitably perpendicular to the top 114. In the embodiment shown in FIG. 10a, the cleat connector 100 comprises a single extension 120a. Each extension comprises a number of securing portions. In one embodiment, the extension portion 120a comprises one or more apertures 121a. In the embodiment shown in FIG. 10a, extension 120a extends away from top 114. It will be appreciated that, depending on the situation, the extension may be located at different angles relative to one another. Alternatively, only a single extension may be present when a single timber structure is required. In an embodiment, the timber structure is a timber beam. FIG. 10b shows the embodiment of FIG. 10b secured to a timber structure.

Shown in FIG. 10c is an embodiment of a cleat connector. For ease of description, the cleat connector shown in FIG. 10c has been numbered with a similar numbering system as FIG. 10a. The main difference between the cleat connector of FIG. 10a and FIG. 10c is that the extension 120a comprises a pair of securing portions. In the embodiment shown, the extension 120a comprises two pairs of apertures (121a, 121b) each adapted to secure a different structure. Shown in FIG. 10d shows the embodiment of FIG. 10c secured to a timber structure.

Shown in FIG. 10e is an embodiment of a cleat connector. For ease of description, the cleat connector shown in FIG. 10c has been numbered with a similar numbering system as FIG. 10a. The main difference between the cleat connector of FIG. 10e and FIG. 10a is that the cleat connector of FIG. 10e comprises a pair of extensions 120a/120b. The extensions 120a/120b extend away from the top 114. In one embodiment, the extension 120a/120b are perpendicular to top. In an embodiment, the extension 120a is perpendicular to extension 120b. The extension 120a comprises apertures 121a adapted to secure a structure. The extensions 120b comprises apertures 121′ adapted to secure to a different structure. Shown in FIG. 10f shows the embodiment of FIG. 10e secured to a timber structure.

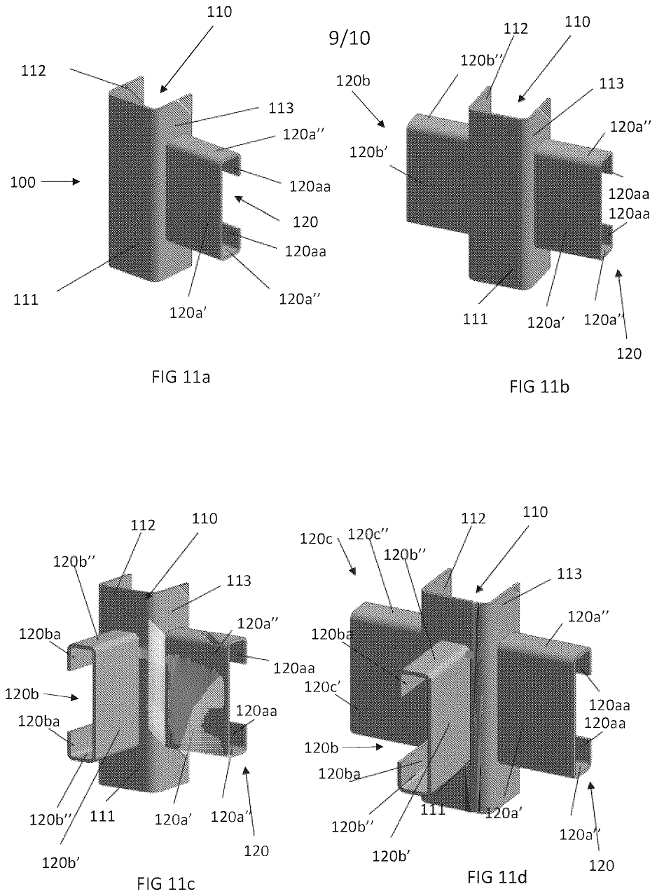

In one embodiment, the extensions mentioned herein may suitably comprise a first wall adapted to secure to the structure. In a further embodiment, the extensions may further comprise a pair of walls extending from opposing ends of the first wall. Each of these walls may suitably comprise an extension towards the opposing wall. In this regard, the extensions may have a ‘C’ channel adapted to receive the structure and/or be received in a structure. In one embodiment, the extension may comprise or be in the form of a parallel flange channel. Shown in FIG. 11a-d are embodiments of a cleat connector. For ease of description, the cleat connector shown in FIG. 11a-d has been numbered with a similar numbering system as FIG. 1. Shown in FIG. 11a is an embodiment of a cleat connector that comprises a single extension 120a. FIG. 11b shows an embodiment of a cleat connector that comprises a pair of extensions 120a, 120b located generally in the same plane to one another. FIG. 11c shows an embodiment of a cleat connector that comprises a pair of extensions 120a, 120b that are orientated perpendicular to one another. FIG. 11d shows an embodiment of a cleat connector that comprises three extensions 120a, 120b, 120c. Each of the extensions shown in FIGS. 11a-c comprises a pair of walls extending from opposing ends of the first wall. The distal end of these pairs of walls are further provided with extending member towards an opposing wall. It should be clear that the extension has a substantially ‘C’ shaped channel. In the embodiment shown, each of the extensions 120a, 120b, 120c comprise a first wall 120a′, 120b′, 120c′ and a pair of walls 120a″, 120b″, 120c″ extending from opposing ends thereof. Each of the pair of walls 120a″, 120b″, 120c″ are provided with a lip 120aa, 120ba, 120ca extending towards the other wall.

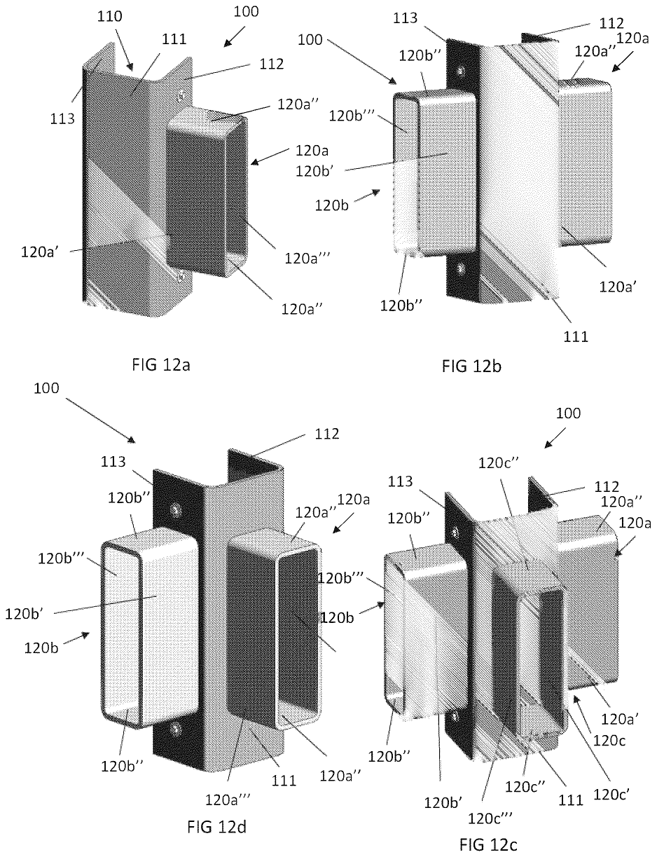

In another embodiment, the extension may suitably comprise a first wall adapted to secure the structure. In a further embodiment, the extensions may further comprise a pair of walls extending from opposing ends of the first and a second wall connecting the distal ends of the pair of walls. In this embodiment, the extensions have a parallelogram cross-section. In an embodiment, the extension are square or rectangular cross-section. Shown in FIGS. 12a-d are embodiments of a cleat connector. For ease of description, the cleat connector shown in FIGS. 12a-d has been numbered with a similar numbering system as FIGS. 11a-c. The main differences between these embodiments are that the cleat connects shown in FIGS. 12a-d comprise a second wall (120a″, 120b″, 120c″, 120d″) connecting the pair of walls. It should be clear, in the embodiments, the each of the extensions 120a, 120b, 120c have a rectangular cross-section. These are suitably adapted to be received in a rectangular hollow section.

The present invention alleviates many of the issues mentioned hereinabove. Typically, a welder is required to weld cleats to metal structures. It will be appreciated that this is expensive and time consuming. The present invention allows for cleats to be attached to metal structures by simply locating a metal structure in the channel of the body, and sliding the cleat connector to the desired location. The cleat connector can then be secured at the appropriate height using a fastening member. Furthermore, multiple cleats can be connected utilizing the same cleat connector. Furthermore, in some embodiments, the angle of the cleats relative to the cleat connector can be adjusted to suit the circumstances.

Furthermore, the present invention allows for cleats to be connected to the top of column structures. Similar to the above, this alleviates many of the issues mentioned hereinabove. Particularly, the present invention allows for the cleat to seat on top of the column structures which provides a stable base to secure the cleat connector thereto. Furthermore, the present invention allows for a structure to be seated on the top when connecting to the cleat. Again, this provides a stable base to secure the structure to the cleat connector.

In one embodiment, the cleat connector for use in balconies, verandahs beams, roof beams, floor bearer supports, garages, carports, pergolas and/or stair landings. In an embodiment, the cleat connector when used in balconies, verandahs beams, roof beams, floor bearer supports, garages, carports, pergolas and/or stair landings.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching.

Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above-described invention.

Changes and modifications in the specifically-described embodiments may be carried out without departing from the principles of the present invention, which is intended to be limited only by the scope of the appended claims as interpreted according to the principles of patent law including the doctrine of equivalents.

1. A cleat connector for attachment to a square hollow section box comprising:
a body having a channel adapted to slidably receive and secure to the square hollow section box, the body comprising a base and a pair of walls extending from opposing ends thereof that define the channel, the pair of walls including a first wall and a second wall; and
at least one extension adapted to secure a structure thereto;
wherein the cleat connector is integrally formed.

2. The cleat connector of claim 1, wherein the cleat connector includes two or three extensions adapted for securing the structure thereto.

3. The cleat connector of claim 1, wherein each extension of the at least one extension extends perpendicularly away from the base, the first wall or the second wall.

4. The cleat connector of claim 1, wherein the base, the first wall or the second wall comprise at least one attachment portion adapted to secure to the square hollow section box.

5. The cleat connector of claim 1, wherein each extension of the at least one extension comprises a side wall adapted to receive one or more securing portions adapted to secure to the structure.

6. The cleat connector of claim 5, wherein the securing portion is rotatably connected to the side wall.

7. The cleat connector of claim 6, wherein the securing portion is rotatable in the plane of the side wall.

8. The cleat connector of claim 1, wherein each extension of the at least one extension comprises at least one aperture adapted to secure to the structure.

9. The cleat connector of claim 1, wherein the body further comprises a top connected to the base and the pair of walls.

10. The cleat connector of claim 8, wherein the cleat connector includes two or three extensions adapted for securing the structure thereto.

11. The cleat connector of claim 9, wherein each extension of the at least one extension extends perpendicularly away from the top.

12. The cleat connector of claim 11, wherein each extension of the at least one extension comprises at least one aperture adapted to secure to the structure.

13. (canceled)

14. (canceled)
